(19) United States
(12) Patent Application Publication
(10) Pub. No.: US 2019/0309836 A1
(43) Pub. Date: Oct. 10, 2019

(54) ACTUATING CYLINDER WITH LOAD SENSOR

(71) Applicant: SKF MOTION TECHNOLOGIES AB, GOTHENBURG (SE)

(72) Inventor: Benoit Laurent, La Chavanne (FR)

(21) Appl. No.: 16/379,855

(22) Filed: Apr. 10, 2019

(30) Foreign Application Priority Data
Apr. 10, 2018 (EP) 18166514.2

(51) Int. Cl. F16H 25/22; F16H 25/20; H02K 7/06; F16H 63/06; H02K 7/08

(52) U.S. Cl. CPC F16H 25/2252; F16H 25/2015; F16H 2025/2078; F16H 63/062; H02K 7/08; H02K 7/06

(57) ABSTRACT

An actuating cylinder has a housing with a main body and a front cover. An actuation rod is mounted for longitudinal movement relative to the housing. An electric motor has a stator and a rotating rotor shaft that is disposed around a screw of a screw mechanism that is connected to the actuation rod. A plurality of rolling elements convert a rotational movement of the rotor shaft into a linear, translation movement of the screw and of the actuation rod. A bearing supports the rotation of the rotor shaft with respect to the housing. A load path ring has an outer ring portion in axial abutment against a fixed part of the bearing, and an inner ring portion connected internally to the outer ring portion. A load sensor is axially clamped between the front cover and the inner ring portion of the load path ring.

### CROSS-REFERENCE TO RELATED APPLICATION

This application claims the priority, under 35 U.S.C. § 119, of European patent application EP 18166514, filed Apr. 10, 2018; the prior application is herewith incorporated by reference in its entirety.

### BACKGROUND OF THE INVENTION

### Field of the Invention:

The invention lies in the technical field of actuating cylinders and relates, in particular, to the field of compact electromechanical cylinders with integrated electric motor.

An electromechanical actuating cylinder generally comprises a housing, an actuation rod mounted so as to be movable longitudinally relative to the housing, an electric motor having a stator and a rotor shaft, a mechanism for converting the rotational movement of the rotor shaft of the motor into a linear movement for translation of the actuation rod, and at least one bearing for guiding in rotation and supporting the rotor shaft with respect to the housing.

Such mechanism can be a screw mechanism including a screw provided with an external thread, a nut disposed around the screw and having an internal thread, and a plurality of rolling elements engaged between and with the internal and external threads. Those elements may be rollers if the mechanism is a roller screw type mechanism, or they may be balls if the mechanism is a ball screw type mechanism.

In the case of an inverted planetary screw mechanism, the nut is driven in rotational movement by the rotor of the electric motor, the screw having then a translating movement by the intermediary of the rolling elements. The screw is connected to the rod. In order to guide in rotation and support the nut, the electromechanical cylinder further comprises bearings arranged between the nut and the housing. The nut is advantageously a rotor shaft or connected to the rotor shaft.

It is known to use sensing devices in assemblies comprising moving parts in order to analyze, control and survey key parameters of those parts. Sensing devices, in particular load sensors, are powered by external power supply means and data are transmitted to control means. The knowledge of the level and variations of such parameters allows quantifying the assembly efficiency, the wear and degradation of parts, and ensuring a better management of preventive maintenance.

The load sensor has to be installed between mounting surfaces and then is located at specific force transmission paths.

However, it is highly complex to integrate a load sensor within an electromechanical actuating cylinder. The constituting parts are all in rotation and/or translation movement which are not suitable for the integration of sensing device cables used for powering and data transfer.

A well-known solution is the integration of a load sensor between the housing and a fixed part of a bearing that support the rotor shaft. However, the dimension of the load sensor is directly linked to the bearing dimension and the load sensor may not be adapted for some applications.

Another solution is to integrate the load sensor in a push tube connected to a rod end, as disclosed in U.S. Pat. No. 7,856,900 B2 to Benoit et al. and its counterpart European published patent application EP 1 587 205 A1. In that case, however, the wire connected to the load sensor moves with the push tube displacement, and the parts of the actuating cylinder require specific and complex designs.

### BRIEF SUMMARY OF THE INVENTION

It is accordingly an object of the invention to provide an actuating cylinder which overcomes the above-mentioned and other disadvantages of the heretofore-known devices and methods of this general type.

With the foregoing and other objects in view there is provided, in accordance with the invention, an actuating cylinder, comprising:

a housing having a main body and a front cover formed with a throughhole;

an actuation rod mounted to be longitudinally movable relative to said housing and extending through said throughhole of said front cover;

a screw mechanism including a screw formed with an external thread and connected to said actuation rod;

an electric motor having with a stator and a rotatable rotor shaft with an internal thread, said rotor shaft being disposed around said screw;

a plurality of rolling elements engaged between said internal thread of said rotor shaft and said external thread of said screw (40, wherein a rotational movement of said rotor shaft is converted into a linear movement in translation of said screw and of said actuation rod; and at least one bearing for guiding a rotation of said rotor shaft and for supporting said rotor shaft with respect to said main body of said housing;

a load path ring having an outer ring portion fixed in said main body of said housing and in axial abutment against a fixed part of said at least one bearing, and an inner ring portion connected inwardly to said outer ring portion; and

a load sensor axially clamped and preloaded between said front cover of said housing and said inner ring portion of said load path ring.

In other words, the invention relates to an actuating cylinder comprising a housing having a main body, a front cover; an actuation rod extending through a cover bore of the front cover and mounted to be movable longitudinally relative to the housing; an electric motor provided with a stator and with a rotating rotor shaft; a screw mechanism including a screw provided with an external thread and connected to the actuation rod, the rotor shaft being disposed around the screw and having an internal thread, and a plurality of rolling elements engaged with the internal and external threads, the rotational movement of the rotor shaft being converted into a linear movement in translation of the screw and of the actuation rod; and comprises at least one bearing for guiding in rotation and supporting the rotor shaft with respect to the main body of housing.

According to the invention, the actuating cylinder further comprises a load path ring having an outer ring portion fixed in main body of housing and in axial abutment against a fixed part of the at least one bearing, and an inner ring portion connected internally to said outer ring portion. The actuating cylinder also comprises a load sensor axially clamped and preloaded between the front cover and the inner ring portion of the load path ring.

In accordance with various advantageous embodiments of the invention, the actuating cylinder may incorporate one or more of the following features:
The actuating cylinder comprises at least two axially adjacent bearings.
The at least one bearing is a rolling bearing having a fixed outer ring fixed in a bore of the main body of housing, a rotating inner ring fixed to an outer surface of the rotor shaft, and at least one row of rolling elements between the rings.
The rolling elements of ball bearing are balls.
The at least two adjacent bearings are oblique ball bearings.
The rolling elements of screw mechanism are rollers having each an external thread which is engaged in the external and internal threads of the screw and the rotor shaft, respectively.
The rolling elements of screw mechanism are balls engaged in external and internal threads of screw and rotor shaft, respectively.
The housing comprises a rear cover.
The main body of housing comprises a stepped bore with an inwardly projecting shoulder, the fixed part of the at least one bearing being axially clamped between the outer ring portion and the said shoulder.
The outer ring portion is an axial tube having a bore through which the actuation rod extends.
The inner ring portion extends inwardly radially from an axial side of outer ring portion, said inner ring portion having a bore through which the actuation rod extends.
The load path ring is formed integral.
The front cover comprises a radial cover portion provided with the cover bore through which the actuation rod extends, the load sensor being in axial abutment against the said radial cover portion.
The front cover comprises an axial cover flange directed axially towards the main body of housing and securely fixed to the main body of housing.
The front cover is formed integral.
The radial cover portion comprises a recess wherein the load sensor is arranged.
The inner ring portion is formed with a recess wherein the load sensor is arranged

Other features which are considered as characteristic for the invention are set forth in the appended claims.

Although the invention is illustrated and described herein as embodied in an actuating cylinder with a load sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

FIG. 1 of the drawing is an axial sectional view of an electromechanical actuating cylinder according to the present invention; and

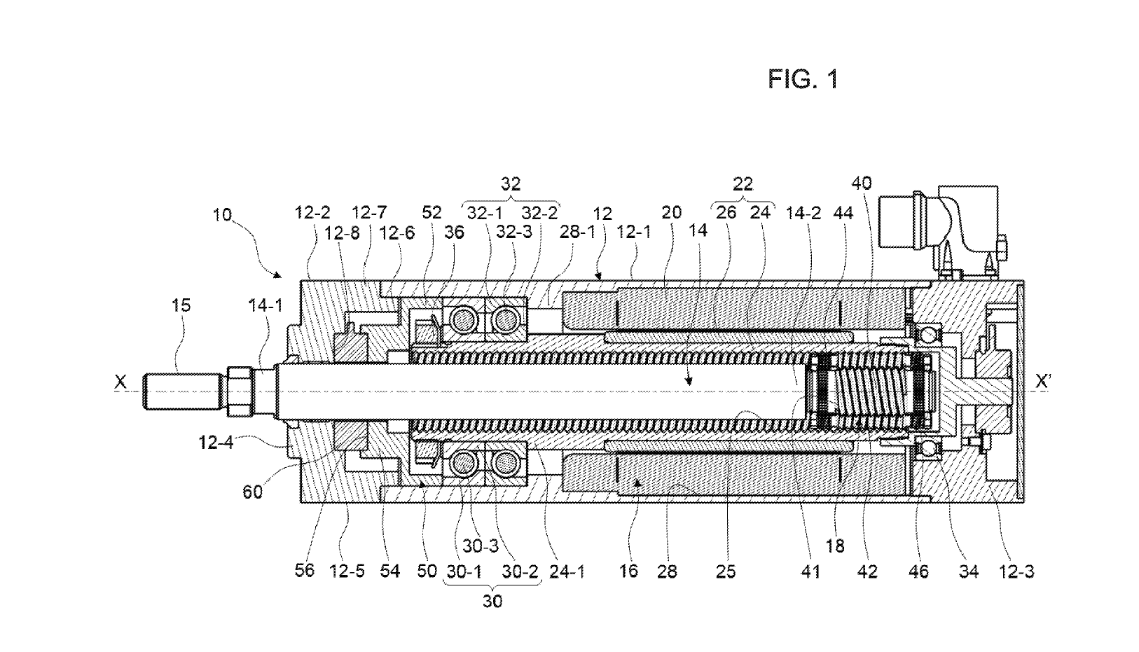

FIG. 2 is a partial view of the actuating cylinder illustrating an exemplary embodiment of the wiring and exterior access to the load sensor.

### DETAILED DESCRIPTION OF EMBODIMENTS OF THE INVENTION

Referring now to the figures of the drawing in detail, there is shown a compact electromechanical actuating cylinder 10, which extends along a longitudinal axis X-X′. The actuating cylinder 10 comprises a housing 12, an actuation rod 14 that is movable axially and coaxially with the axis X-X′, a push tube 15 connected to a first end 14-1 of the actuation rod, an electric motor 16, and an inverted planetary roller screw mechanism 18 disposed inside the housing 12. The screw mechanism 18 is disposed radially between the electric motor 16 and the actuation rod 14.

The mechanism 18 enables a conversion of a rotary movement of the electric motor 16 into a linear movement in translation of the actuation rod 14 along the axis X-X′. The electric motor 16 and the screw mechanism 18 are housed entirely within the housing 12. The actuation rod 14 extends through the housing 12 and protrudes axially to the outside.

In the illustrated exemplary embodiment, the housing 12 comprises a tubular main body 12-1 having a bore 28, a front cover 12-2, and a rear cover 12-3. The front and rear covers are each fixed at a respective end of the main body 12-1.

The front cover 12-2 comprises a radial cover portion 12-4 which is formed with a bore, or throughhole, through which the actuation rod 14 extends, and an axial cover flange 12-5 that axially extends from an outer edge of the radial cover portion 12-4 towards the main body 12-1. The axial cover flange 12-5 is advantageously stepped. A portion of smaller diameter 12-6 of the flange 12-5 is thereby arranged in the bore 28 of main body 12-1. Another portion with a greater diameter 12-7 of the flange 12-5 forms an outwardly radially projecting shoulder that is in axial abutment against the main body 12-1.

Advantageously, the flange 12-5 of the front cover 12-2 is securely fixed to the main body 12-1. For example, the portion of lower diameter 12-6 comprises an outer thread and the bore 28 comprises a portion with inner thread. The portion 12-6 may thus be screwed into the bore 28, with the inner and outer threads meshing with one another. Alternatively, the front cover 12-2 may be fixed by welding, screws, or any other suitable fixing means to the main body 12-1.

In an advantageous embodiment, the front cover 12-1 is integrally formed in one piece.

The electric motor 16 comprises a stator 20 fixed on the housing 12, and a rotor 22. The stator 20 is fixed in the bore 28 of the main body 12-1 of the housing 12. The bore 28 is advantageously stepped and comprises an inwardly radially projecting shoulder 28-1, the stator being in axial abutment against said shoulder 28-1 towards a front axial direction. The rotor 22 is provided with a tubular rotor shaft 24 and a plurality of permanent magnets 26 supported by said shaft 24.

The rotor shaft 24 extends axially on either side of the stator 20. The electric motor 16 can be of the brushless type, or alternatively of any other suitable type.

In order to guide in rotation and support the rotor shaft 24 with respect to the housing 12, the actuating cylinder 10 also comprises two front rolling bearings 30, 32 and one rear rolling bearing 34. In the illustrated exemplary embodiment, the bearings 30, 32, 34 are each of ball type. Alternatively, the bearing may be of any other suitable types, for example with tapered rollers or cylindrical rollers.

The rear rolling bearing 34 is mounted in the rear cover 12-3 of housing 12.

The front rolling bearings 30, 32 are axially adjacent one to another and comprise each a fixed outer ring 30-1, 32-1, a rotating inner ring 30-2, 32-2, and a row of balls 30-3, 32-3, respectively.

The fixed outer rings 30-1, 32-1 of bearings 30, 32 are fixed in the stepped bore 28 of main body 12-1 of housing 12. The fixed inner ring 32-1 of bearing 32 is in axial abutment against the shoulder 28-1 towards a rear axial direction. The fixed outer rings 30-1, 32-1 comprise each a bore with an outer raceway having, in cross-section, a concave inner profile adapted to the balls 30-3, 32-3, respectively. The rotating inner rings 30-2, 32-2 of bearings 30, 32 are fixed to an outer surface of rotor shaft 24, said rings being axially clamped between an outwardly radially projecting shoulder 24-1 provided on outer surface of rotor shaft 24, and a fixing ring 36 fixed to said rotor shaft 24. The rotating inner rings 30-2, 32-2 comprise each an outer surface with an inner raceway having, in cross-section, a concave inner profile adapted to the balls 30-3, 32-3, respectively.

The front rolling bearings 30, 32 are advantageously oblique in an O-shaped configuration to support loads in both axial directions. Alternatively, the front rolling bearings may be in an X-shaped configuration.

The push tube 15 is annular and comprises a portion with an outer thread that is screwed in an inner thread provided to a bore portion of the first end 14-1 of actuation rod 14.

The inverted planetary roller screw mechanism 18 comprises a screw 40, which is coaxial and connected to a second end 14-2 of the actuation rod 14. The push tube 15 and the screw 40 are axially opposite one to another with respect to the actuation rod 14.

The rotor shaft 24 is of tubular shape, coaxial with the screw 40 and is disposed around said screw 40. The screw 40 comprises an external thread 41, and the rotor shaft 24 comprises an internal thread 25 of which the inner diameter is greater than the outer diameter of the external thread 41 of screw 40.

The screw mechanism 18 further comprises a plurality of rollers 42 having each an external thread (not referenced) which is engaged in the external and internal threads 41, 25 of the screw 40 and the rotor shaft 24, respectively. The rollers 42 are identical to one another and are distributed uniformly around the screw 40. Each roller 42 extends along an axis parallel to the screw axis. As is known per se, each roller 42 comprises, at each end (not referenced), an outer toothing engaged with a synchronization toothing of the screw, and a journal extending axially to the outside from the toothing and housed in a recess in one of the spacer rings 44, 46 mounted around said screw 40.

As an alternative, which is not illustrated, the rolling elements are balls that are engaged in external and internal threads of the screw and the rotor shaft, respectively.

The actuation rod 14 is connected to the screw 40 of the screw mechanism 18. The rotation of the rotor shaft 24 of the electric motor 16 is converted into a translation of the screw 40 and of the actuation rod 14 along the axis X-X′.

According to the invention, the actuating cylinder 10 further comprises a load path ring 50.

The load path ring 50 is provided with an outer ring portion 52 formed as an axial tube. The outer ring portion 52 comprises a bore through which the actuation rod 14 extends. The outer ring portion 52 is fixed in the bore 28 of the main body 12-1 of housing 12. The outer ring portion 52 is in axial abutment against the fixed outer ring 30-1 of the rolling bearing 30 on the rear axial side of ring. The outer ring portion 52 is axially facing the portion of smaller diameter 12-6 of flange 12-5 of front cover 12 on the front axial side of ring, an axial gap being defined between them.

The load path ring 50 is further provided with an inner ring portion 54 that is connected internally to said outer ring portion 52. The inner ring portion 54 extends inwardly radially from a front axial side of outer ring portion 52. The inner ring portion 52 has a bore through which the actuation rod 14 extends.

The load path ring 52 is advantageously formed integral.

The actuating cylinder 10 also comprises a load sensor 60 having a bore through which the actuation rod 14 extends. The load sensor 60 is in axial abutment against the radial cover portion 12-4 of front cover 12-1 on the front axial side of sensor. The load sensor 60 is in axial abutment against the inner ring portion 54 of the load path ring 50 on the axially rear side of the sensor.

The load sensor 60 is then mounted axially preloaded between the load path ring 50 and the font cover 12-2. One can calibrate a reference preload value when the actuating cylinder is not loaded.

Advantageously, the radial cover portion 12-4 and the inner ring portion 52 comprise each a recess 12-8 and 56, respectively, wherein the load sensor 60 is arranged. The load sensor 60 is then axially and radially securely maintained between the front cover 12-2 and the load path ring 50.

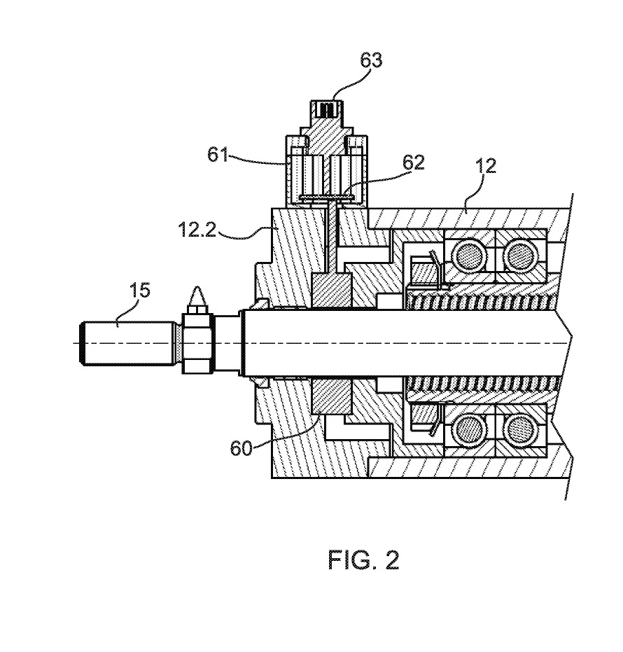

Referring now to FIG. 2, the load sensor 60 is wired towards the outside of the housing 12 towards an electronics housing 61 that is mounted to the outside of the housing 12. The load sensor 60, by way of example, may be a piezo sensor or a strain gauge device. The electronics housing 61 encloses a signal amplifier 62 for the sensor signals. The signal amplifier 62 is wired to a plug connector 63 on the outside of the housing 61. The sensor signals can thus be tapped at the plug connector 63.

The load sensor 60 for the actuating cylinder 10 works as follows:

When the push tube 15 is in axial compression load, the load is exerted from the front axial side towards the rear axial side of the actuating cylinder 10. The load is transmitted from the push tube 15 in succession to the actuation rod 14, the screw 40, the rollers 42, the rotor shaft 24, the ring 36, the rotating inner ring 30-2, the balls 30-3, the fixed outer ring 30-1, the fixed outer ring 32-1, the shoulder 28-1, and then the main body 12-1 of housing 12. The preload value on the load sensor 60 decreases accordingly with the axial compression load. The load sensor 60 can sense this load difference, and then process and transmit a load measurement value. The load measurement value is available in the form of an electronic signal at the plug connector 63.

On the contrary, when the push tube 15 is in axial traction load, the load is exerted on the rear axial side towards the front axial side of the actuating cylinder 10. The load is transmitted from the push tube 15 successively to the actuation rod 14, the screw 40, the rollers 42, the rotor shaft 24, the shoulder 24-1, the rotating inner ring 32-2, the balls 32-3, the fixed outer ring 32-1, the fixed outer ring 30-1, the outer ring portion 52, the inner ring portion 54, and then the load sensor 60 that is pressed against the fixed front cover 12-2.

The load sensor 60 is loaded, and the preload value on the load sensor 60 increases accordingly with the axial traction load. The load sensor 60 can sense this load difference, and then process and transmit a load measurement.

Due to the novel assembly according to the invention, the load sensor 60 can sense the compression and traction axial loads exerted on the push tube 15, and then to the actuation cylinder 10 in service.

The load sensor 60 is integrated in the fixed cover 12-2 of housing 12, and then the load sensor 60 is fixed. The load sensor 60 can be easily wired, the other parts of the actuating cylinder 10 are not impacted by the integration of the load sensor.

Another advantage is that the actuating cylinder axial dimension is not dramatically increased to integrate the load sensor 60. The load sensor 60 can be arranged in a front cover 12-2 of standard dimensions, only the internal design of said cover being modified to receive the said load sensor.

Representative, non-limiting examples of the present invention were described above in details with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved actuating cylinder.

Moreover, various features of the above-described representative examples, as well as the various independent and dependant claims below, may be combined in ways that are not specifically and explicitly enumerated in order to provide additional useful embodiments of the present teachings.

1. An actuating cylinder, comprising:
a housing having a main body and a front cover formed with a throughhole;
an actuation rod mounted to be longitudinally movable relative to said housing and extending through said throughhole of said front cover;
a screw mechanism including a screw formed with an external thread and connected to said actuation rod;
an electric motor having with a stator and a rotatable rotor shaft with an internal thread, said rotor shaft being disposed around said screw;
a plurality of rolling elements engaged between said internal thread of said rotor shaft and said external thread of said screw, wherein a rotational movement of said rotor shaft is converted into a linear movement in translation of said screw and of said actuation rod; and
at least one bearing for guiding a rotation of said rotor shaft and for supporting said rotor shaft with respect to said main body of said housing;
a load path ring having an outer ring portion fixed in said main body of said housing and in axial abutment against a fixed part of said at least one bearing, and an inner ring portion connected inwardly to said outer ring portion; and
a load sensor axially clamped and preloaded between said front cover of said housing and said inner ring portion of said load path ring.

2. The actuating cylinder according to claim 1, wherein said at least one bearing is a rolling bearing having a fixed outer ring fixed in a bore of said main body of said housing, a rotating inner ring fixed to an outer surface of said rotor shaft, and at least one row of rolling elements disposed between said outer and inner rings.

3. The actuating cylinder according to claim 2, wherein said rolling elements are balls and said at least one bearing is one of at least two adjacent oblique bearings.

4. The actuating cylinder according to claim 1, wherein said main body of said housing is formed with a stepped bore having an inwardly projecting shoulder, wherein a fixed part of said at least one bearing is axially clamped between said outer ring portion of said load path ring and said shoulder.

5. The actuating cylinder according to claim 1, wherein said outer ring portion of said load path ring is an axial tube formed with a bore through which said actuation rod extends.

6. The actuating cylinder according to claim 5, wherein said inner ring portion extends inwardly radially from an axial side of said outer ring portion, and said inner ring portion is a bore through which said actuation rod extends.

7. The actuating cylinder according to claim 1, wherein said front cover comprises a radial cover portion formed with said throughhole through which said actuation rod extends and said load sensor is in axial abutment against said radial cover portion.

8. The actuating cylinder according to claim 7, wherein said radial cover portion is formed with a recess and said load sensor is arranged in said recess.

9. The actuating cylinder according to claim 1, wherein said front cover comprises an axial cover flange directed axially towards said main body of said housing and securely affixed to said main body.

10. The actuating cylinder according to claim 1, wherein said front cover is integrally formed as a single element.

11. The actuating cylinder according to claim 1, wherein said housing further comprises a rear cover.

12. The actuating cylinder according to claim 1, wherein said inner ring portion is formed with a recess and said load sensor is arranged in said recess.

13. The actuating cylinder according to claim 1, wherein said rolling elements of said screw mechanism are rollers each having an external thread configured to mesh in engagement with said external thread of said screw and said internal thread of said rotor shaft.

14. The actuating cylinder according to claim 1, wherein said rolling elements of said screw mechanism are balls respectively engaged in said external thread of said screw and said internal thread of said rotor shaft.
